(19) United States
(12) Patent Application Publication
(10) Pub. No.: US 2004/0134033 A1
(43) Pub. Date: Jul. 15, 2004

(54) Friction hinge assembly for a mirror of a display unit

(76) Inventors: Aaron Raines, Dallas, TX (US); Joel F. Theall, Plano, TX (US); Eduardo Gracia, Mesquite, TX (US)

Correspondence Address: BAKER BOTTS L.L.P., 2001 ROSS AVENUE, SUITE 600, DALLAS, TX, 75201-2980, US

(21) Appl. No.: 10/627,842

(22) Filed: Jul. 25, 2003

Related U.S. Application Data
(60) Provisional application No. 60/399,492, filed on Jul. 29, 2002.

(51) Int. Cl. E05D 11/08

(52) U.S. Cl. 16/342

(57) ABSTRACT

A friction hinge assembly for an imaging mirror of a display unit includes a mounting base coupled to a housing of the display unit. The mounting base comprises a longitudinal pin portion. The assembly includes a hinge member coupled to the imaging mirror. The hinge member is positioned substantially around the pin portion, and the hinge member comprises a support portion. The pin portion is configured to apply a friction caused by contact of the pin portion with the support portion of the hinge member. The hinge member is configured to rotate about the pin portion from a first position to a second position without the friction, and the hinge member is configured to rotate about the pin portion from the second position to a third position with the friction.

### RELATED APPLICATION

This application claims the benefit of U.S. provisional application Serial No. 60/399,492, filed Jul. 29, 2002, entitled Friction Hinge Assembly for a Mirror of a Display Unit.

### TECHNICAL FIELD OF THE INVENTION

This invention relates generally to display units and, more particularly, to a friction hinge assembly for a mirror of a display unit.

### BACKGROUND OF THE INVENTION

During daylight hours, the driver of a vehicle is able to readily detect and recognize objects that would be difficult or impossible to detect or recognize at night. Consequently, in order to supplement the natural vision of a driver, and thus reduce the risk of accidents, night vision systems have been developed for vehicles, including automobiles sold in the consumer market. Typical night vision systems include an infrared camera unit, which gathers information regarding the scene in front of the vehicle, mounted in the grill of the vehicle and a head-up display, which projects an image derived from information provided by the camera unit onto an imaging mirror for view by the driver of the vehicle.

### SUMMARY OF THE INVENTION

The present invention provides a friction hinge assembly for a mirror of a display unit that substantially eliminates or reduces at least some of the disadvantages and problems associated with previous assemblies.

In accordance with a particular embodiment of the present invention, a friction hinge assembly for an imaging mirror of a display unit includes a mounting base coupled to a housing of the display unit. The mounting base comprises a longitudinal pin portion. The assembly includes a hinge member coupled to the imaging mirror. The hinge member is positioned substantially around the pin portion, and the hinge member comprises a support portion. The pin portion is configured to apply a friction caused by contact of the pin portion with the support portion of the hinge member. The hinge member is configured to rotate about the pin portion from a first position to a second position without the friction, and the hinge member is configured to rotate about the pin portion from the second position to a third position with the friction.

The pin portion may comprise at least one corner configured to contact the support portion of the hinge member to apply the friction. The imaging mirror may be in a recessed position within the housing when the hinge member is in the first position, and the imaging mirror may be in a fully deployed position when the hinge member is in the third position. The hinge member may comprise a mounting portion spaced apart from the support portion, and the mounting portion may be coupled to the imaging mirror. An adjustment screw may be inserted through the mounting portion and the support portion to control the friction.

In accordance with another embodiment, a system for displaying an image at a display unit includes a mounting base coupled to a housing of the display unit. The mounting base comprises a longitudinal pin portion. The system includes a hinge member coupled to the imaging mirror. The hinge member is positioned substantially around the pin portion, and the hinge member comprises a support portion. The pin portion is configured to apply a friction caused by contact of the pin portion with the support portion of the hinge member. The hinge member is configured to rotate about the pin portion from a first position to a second position without the friction, and the hinge member is configured to rotate about the pin portion from the second position to a third position with the friction. The system also includes a video source coupled to the display unit to transmit the image to the display unit for reflection by a fold mirror coupled to the housing toward the imaging mirror. The video source may comprise a camera unit of an auxiliary vision system of a vehicle. The display unit may comprise a liquid crystal display operable to project the image onto the fold mirror for reflection toward the imaging mirror.

Technical advantages of particular embodiments of the present invention include a friction hinge assembly that enables an imaging mirror of a display unit to open freely for a certain range (for example, forty to fifty-five degrees), after which a friction is applied to allow a user to manually position the imaging mirror for optimal viewing. The imaging mirror will remain in such position during use as a result of the friction applied by the friction hinge assembly. Furthermore, an adjustment screw is used to control the amount of friction. The adjustment screw is useful to account for wear and tear of the friction hinge assembly over time and to account for manufacturing tolerances in the production of components of the friction hinge assembly.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 is a diagrammatic view of a vehicle incorporating an auxiliary vision system, in accordance with an embodiment of the present invention;

FIG. 2 is a diagrammatic view of the auxiliary vision system of FIG. 1, showing in greater detail the internal structure of a camera unit and a display unit, in accordance with an embodiment of the present invention;

FIG. 3 is a diagrammatic perspective view of a display unit of an auxiliary vision system in an operational position, in accordance with an embodiment of the present invention;

FIG. 4 is a diagrammatic perspective view of the display unit of FIG. 3 in a non-operational position;

FIG. 5 is a diagrammatic perspective view of a display unit with an imaging mirror in an operational position illustrating friction hinge assemblies, in accordance with an embodiment of the present invention;

FIG. 6 is a diagrammatic isometric view of a friction hinge assembly for use in a display unit, in accordance with an embodiment of the present invention;

FIG. 7 is an exploded view of a friction hinge assembly installed in a housing of a display unit, in accordance with an embodiment of the present invention;

FIG. 8 is a diagrammatic isometric view of a lift mechanism for an imaging mirror utilizing friction hinge assemblies, in accordance with an embodiment of the present invention;

FIG. 9 is a diagrammatic side view of a friction hinge assembly as positioned when an imaging mirror is in a recessed position, in accordance with an embodiment of the present invention;

FIG. 10 is a diagrammatic side view of a friction hinge assembly as positioned when an imaging mirror is partially deployed, in accordance with an embodiment of the present invention;

FIG. 11 is a diagrammatic isometric view of a display unit with an imaging mirror in the partially deployed position when the friction hinge assembly is in the position as illustrated in FIG. 10; and

FIG. 12 is a diagrammatic side view of a friction hinge assembly as positioned when an imaging mirror is fully deployed, in accordance with an embodiment of the present invention.

### DETAILED DESCRIPTION OF THE INVENTION

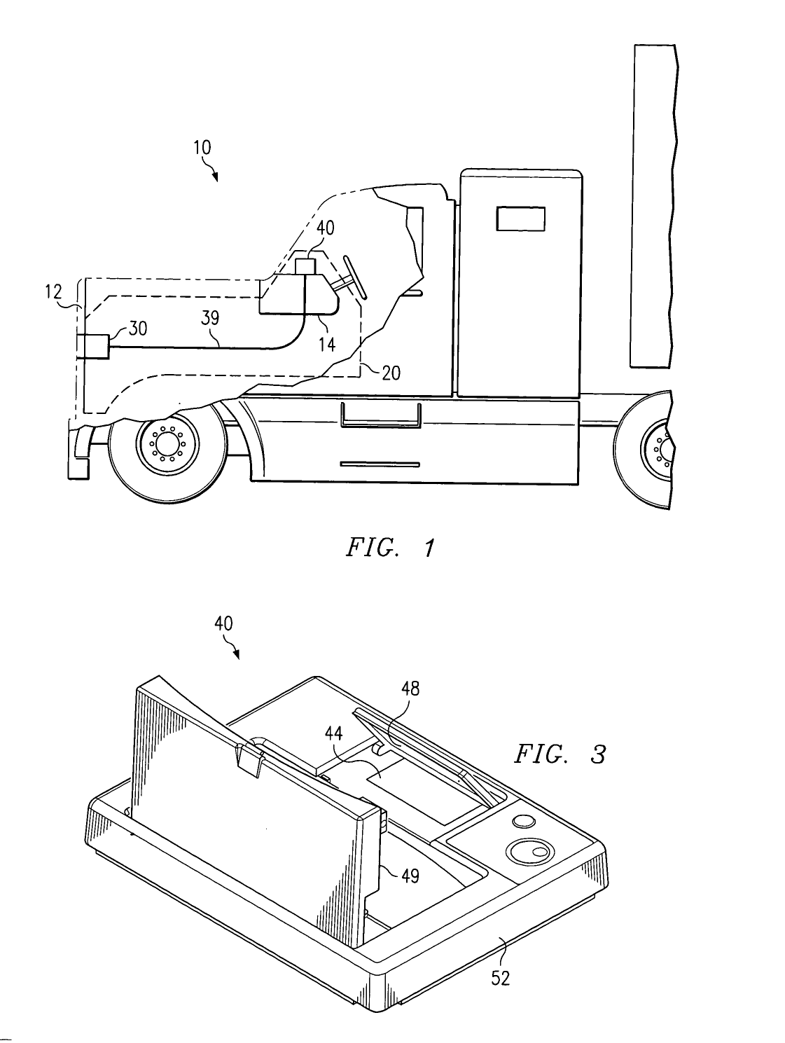

FIG. 1 is a diagrammatic view of a vehicle 10 incorporating an auxiliary vision system 20 in accordance with an embodiment of the present invention. In this embodiment, vehicle 10 is a truck; however, in other embodiments vehicle 10 may be another type of vehicle, such as a recreation vehicle or a car. The auxiliary vision system 20 includes a camera unit 30, which in the illustrated embodiment is mounted at the front of vehicle 10, in the middle of a front grill 12. The camera unit 30 is electrically coupled at 39 to a display unit 40, which is also a part of the auxiliary vision system 20. The display unit 40 is of a type that is commonly known as a head-up display (HUD).

In the illustrated embodiment, the display unit 40 is set on dashboard 14 of the vehicle 10 and can project an image for reflection by a fold mirror of display unit 40 onto an imaging mirror of display unit 40 for display to the driver or a passenger. In particular embodiments, the display unit 40 may be inverted and mounted on the ceiling of vehicle 10 in a position above the dashboard for viewing by the driver or a passenger. Display unit 40 may also be otherwise positioned or mounted within vehicle 10.

When a driver is operating a vehicle at night, the driver's ability to see the road ahead is substantially more limited than would be case for the same section of road during daylight hours. This is particularly true in a rural area under conditions where there is little moonlight, there are no street lights, and there are no headlights of other vehicles.

One feature of auxiliary vision system 20 of FIG. 1 is the ability to provide the driver of the vehicle 10 with information above and beyond that which the driver can discern at night with the naked eye. In this regard, the camera unit 30 can detect infrared information at a distance well beyond the effective reach of the headlights of the vehicle 10. In the case of a life form such as an animal or a human, the heat signature of the life form, when presented in an infrared image derived from the camera unit 30, will usually have a significant contrast in comparison to the relatively hotter or cooler surrounding natural environment. As discussed above, this is not necessarily the case in a comparable nighttime image based on visible light.

Thus, in addition to the visible image that is directly observed by the driver through the windshield of the vehicle based on headlight illumination and any other available light, the auxiliary vision system 20 provides a separate and auxiliary image, based on infrared radiation, that is reflected onto the imaging mirror of auxiliary vision system 20 for view by the driver. This auxiliary image can provide a detectable representation of lifeforms or objects ahead that are not yet visible to the naked eye. Further, the auxiliary image can provide a much more striking contrast than a visible image between the lifeforms or objects and the surrounding scene. Note that the auxiliary vision system 20 may also be useful during daylight hours to supplement the view of objects seen with natural light.

Auxiliary vision system 20 may also include other components, such as an angle encoder and/or an inclinometer to provide information regarding the heading of vehicle 10, such as, for example, steering rate, inclination rate, and/or orientation. Other components may be utilized by auxiliary vision system 20 to present other types of information.

In particular embodiments, display unit 40 may be coupled to a video source other than camera unit 30 and may thus present other types of images. For example, in some embodiments the display unit may be coupled to a global positioning satellite (GPS) system, a dvd player or other component. Text messages, navigation information, dashboard information or other information or images may be displayed by display unit 40.

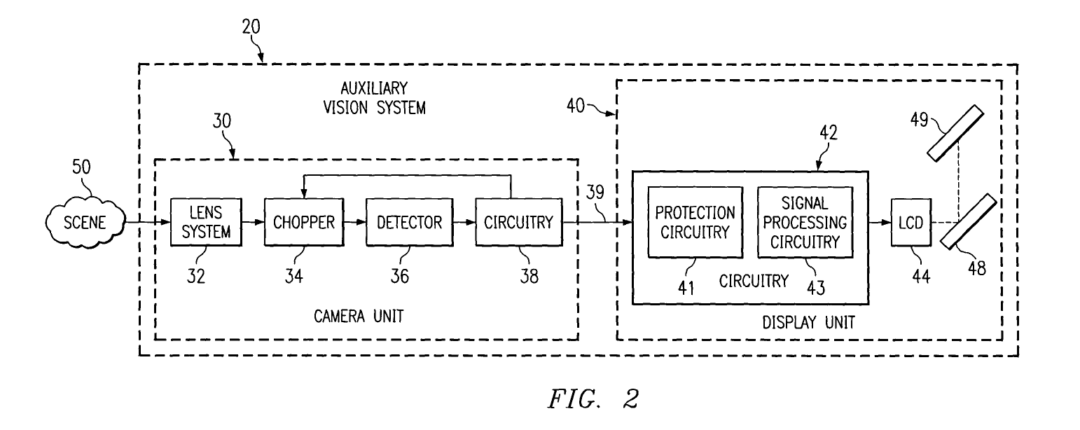

FIG. 2 is a diagrammatic view of the auxiliary vision system 20 of FIG. 1, showing in greater detail the internal structure of both the camera unit 30 and the display unit 40, in accordance with an embodiment of the present invention. More specifically, thermal radiation from a scene 50 enters the camera unit 30 and passes through a lens system 32 and a chopper 34 to a detector 36. The lens system 32 directs the incoming radiation onto an image plane of the detector 36. The chopper 34 is a rotating disk of a known type. As the chopper 34 is rotated, it modulates the incoming infrared radiation to the detector 36.

The detector 36 may be a commercially available focal plane array or staring array detector, which has a two-dimensional matrix of detector elements, where each detector element produces a respective pixel of a resulting image. In particular embodiments, detector 36 may be an uncooled pyroelectric barium strontium titanate (BST) detector, although numerous other types of detectors would also be useful in auxiliary vision system 20.

The circuitry 38 is provided to control the detector 36 and read out the images that it detects, and also to synchronize the chopper 34 to operation of the detector 36. Further, the circuitry 38 sends the information obtained from detector 36 through the electrical coupling 39 to the circuitry 42 within the display unit 40.

The circuitry 42 includes protection circuitry 41 and signal processing circuitry 43. Protection circuitry 41 operates to protect display unit 40 from energy surges, such as load switching spikes and load dumps.

The circuitry 42 controls a liquid crystal display (LCD) 44, which in particular embodiments has a two-dimensional array of pixel elements. The display unit 40 has a horizontal to vertical aspect ratio of 3:1. Other embodiments may include a display unit having a different horizontal to vertical aspect ratio. The circuitry 42 takes successive images obtained from the detector 36 through circuitry 38 and presents these on the LCD 44. The LCD 44 may include backlighting that makes the image on LCD 44 visible at night.

This visible image is projected onto a fold mirror 48 that reflects the image so as to be directed onto imaging mirror 49, creating a virtual image for the driver. Although fold mirror 48 and imaging mirror 49 are shown diagrammatically in FIG. 2 as planar components, each may have a relatively complex curvature that is known in the art. The curvature may also give the mirrors some optical power, so that they impart a degree of magnification to the image.

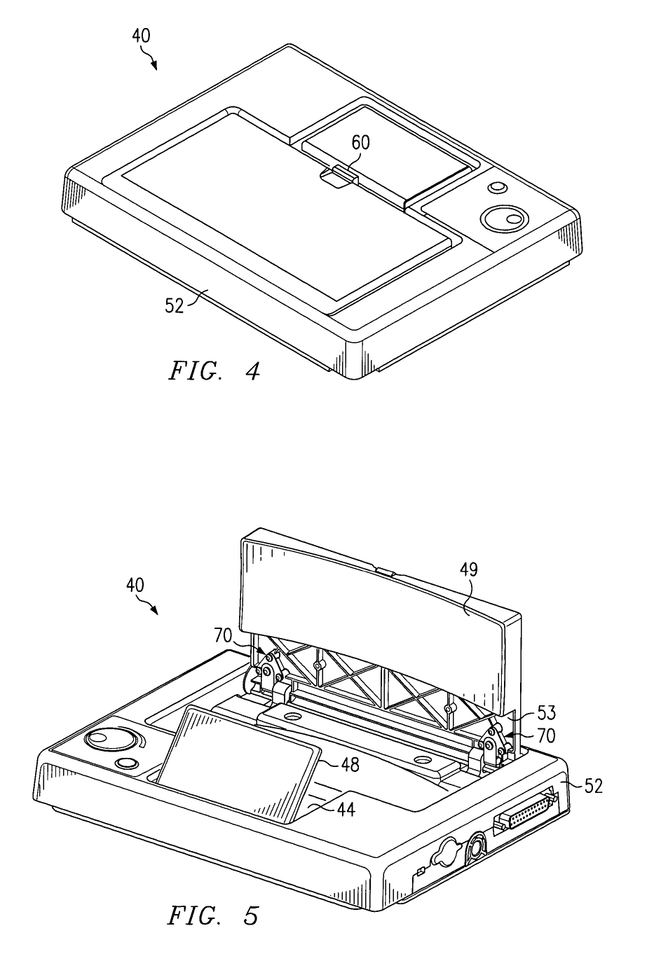

FIG. 3 is a diagrammatic perspective view of display unit 40. In particular embodiments, the display unit 40 may be mounted permanently or removably on top of the dashboard of a vehicle. It may also be mounted invertedly above the dashboard, in which case the image may be inverted by display unit 40 so that it is presented optimally to the driver or a passenger. The display unit 40 may also be positioned in other ways in a vehicle or may be moved from one vehicle to another. Because of its portability, display unit 40 is sometimes referred to as a notebook HUD.

The display unit 40 has an LCD 44, a planar fold mirror 48, and an aspheric imaging mirror 49. Radiation from the LCD 44 travels upwardly to the fold mirror 48 and is reflected toward the imaging mirror 49. This radiation is then reflected by the imaging mirror 49 directly toward the eye of the driver or a passenger. The imaging mirror 49 is supported for pivotal movement relative to a housing 52 and can be pivotally positioned so that the imaging mirror 49 is in a comfortably viewable position for the driver or a passenger. The fold mirror 48 is also supported for pivotal movement.

When the display unit 40 is not being used, the mirrors 48 and 49 can both be pivoted downwardly to a non-operational position in which they are both substantially horizontal. In this regard, FIG. 4 is a diagrammatic perspective view of the display unit 40, and shows the substantially horizontal positions of the mirrors 48 and 49. The ability of mirrors 48 and 49 to pivot to a substantially horizontal position when not in use allows display unit 40 to have a relatively thin profile.

The deployment of mirrors 48 and 49 begins with the release of a latch 60. When latch 60 is released, imaging mirror 49 (and the panel supporting imaging mirror 49) releases and deploys to a partially-opened position, and fold mirror 48 (and the panel supporting fold mirror 48) deploys to its full open position. The imaging mirror 49 may then be opened further to an optimum viewing angle for the driver or a passenger with no further movement of the fold mirror 48.

FIG. 5 is another diagrammatic perspective view of display unit 40 with friction hinge assemblies 70 for use in deploying the imaging mirror 49 to an operational position, as further described below. Friction hinge assemblies 70 are each coupled to the housing 52 and to a panel 53 supporting the imaging mirror 49. Display units in accordance with embodiments of the present invention may utilize one or a plurality of friction hinge assemblies for the deployment of the imaging mirror.

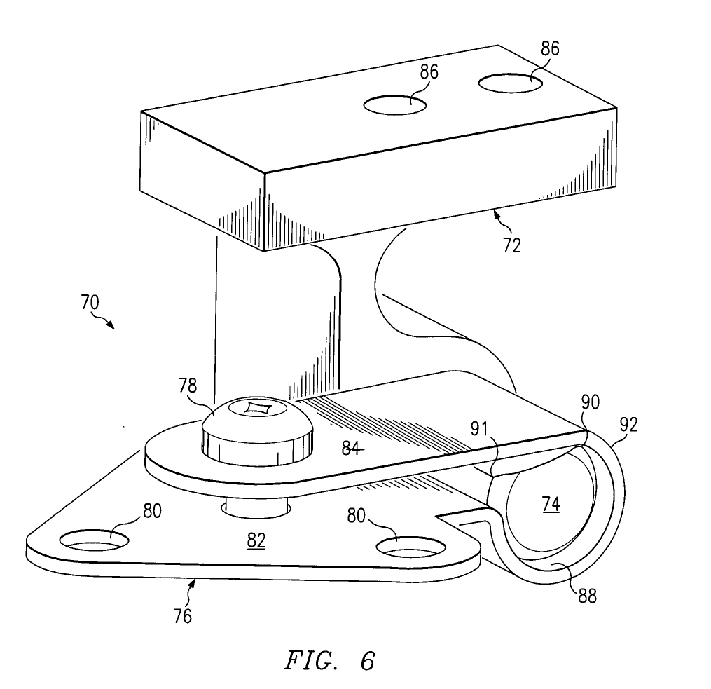

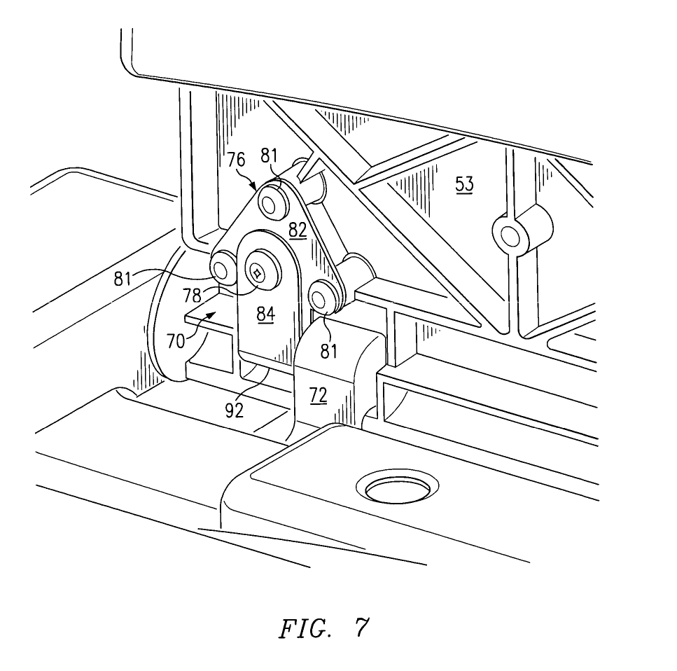

FIG. 6 is a diagrammatic isometric view of friction hinge assembly 70 for use in display unit 40, in accordance with an embodiment of the present invention. Friction hinge assembly 70 includes a mounting base 72 having a protruding pin portion 74. In other embodiments, pin portion 74 may be a separate component coupled to the mounting base 72 and not a part of the mounting base 72. Mounting base 72 couples to the housing 52 of the display unit 40 using screws or other components threaded through base mounting holes 86. It should be understood that mounting base 72 may be coupled to the housing 52 in any of number of ways known to one skilled in the art, with or without using base mounting holes. Base mounting holes having configurations other than those illustrated may be used as well.

Friction hinge assembly 70 also includes hinge member 76. Hinge member 76 couples to the imaging mirror 49 of display unit 40 by coupling to a panel supporting the imaging mirror 49. Hinge member 76 may be coupled to the panel supporting the imaging mirror 49 using screws or other components threaded through hinge mounting holes 80. It should be understood that hinge member 76 may be coupled to the imaging mirror 49 in any of number of ways known to one skilled in the art, with or without using hinge mounting holes 80. Hinge mounting holes having configurations other than those illustrated may be used as well.

Hinge member 76 includes mounting portion 82, support portion 84 and a curved intermediate side 92 which joins mounting portion 82 with support portion 84. Intermediate side 92 substantially surrounds a generally circular gap 88 through which pin portion 74 is positioned. In operation, the hinge member 76 rotates about the longitudinal axis of the pin portion 74 in order to rotationally deploy the imaging mirror 49 coupled to the hinge member 76. In other embodiments, the gap 88 may have a shape or configuration other than that illustrated. Friction hinge assembly 70 includes an adjustment screw 78 that couples mounting portion 82 with support portion 84. In this embodiment, the adjustment screw 78 passes through a clearance hole of support portion 84 and through a threaded hole of mounting portion 82. In other embodiments that utilize an adjustment screw, the holes of the hinge member 76 through which the adjustment screw passes may be configured in other ways.

Pin portion 74 includes corners 90 and 91. The configuration of corners 90 and 91 controls the amount of non-friction travel of the hinge member 76 around the pin portion 74. Thus, since the hinge member 76 is coupled to the imaging mirror 49, the configuration of corners 90 and 91 controls the distance or degree of initial non-friction deployment of the imaging member 49 before friction is encountered.

FIG. 7 is an exploded view of the friction hinge assembly 70 installed in a housing 52 of a display unit 40. As illustrated, mounting portion 82 of hinge member 76 is coupled to the panel 53 which supports the imaging mirror 49 through screws 81. Adjustment screw 78 couples support portion 84 with mounting portion 82. Mounting base 72 is coupled to the housing 52 of the display unit 40 (such coupling is covered from view).

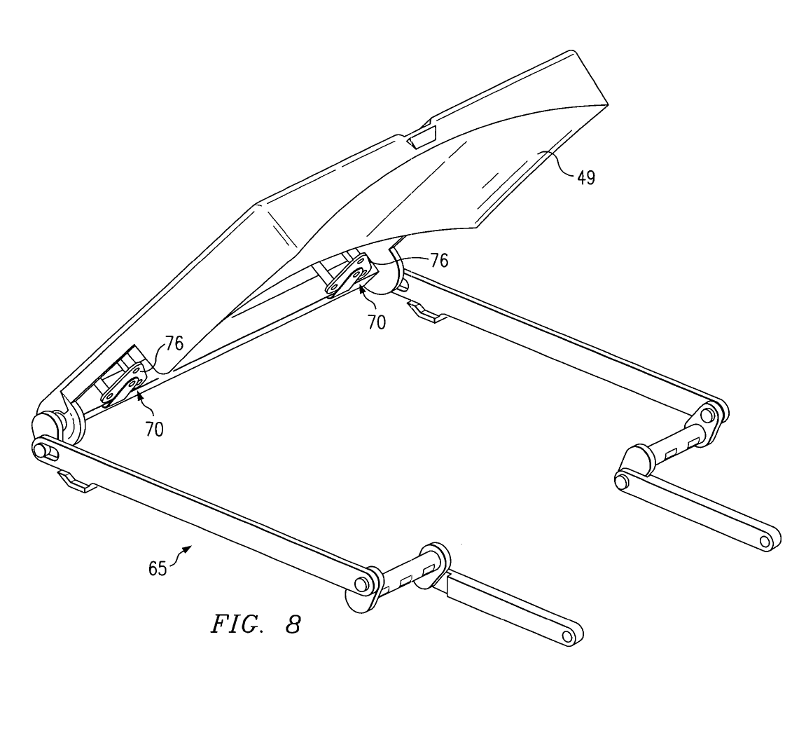

FIG. 8 illustrates a lift mechanism 65 for the imaging mirror 49 of a display unit with friction hinge assemblies 70. The housing in which the illustrated lift mechanism 65 would be installed is not shown for clarity. The hinge members 76 can be seen coupled to the imaging mirror 49.

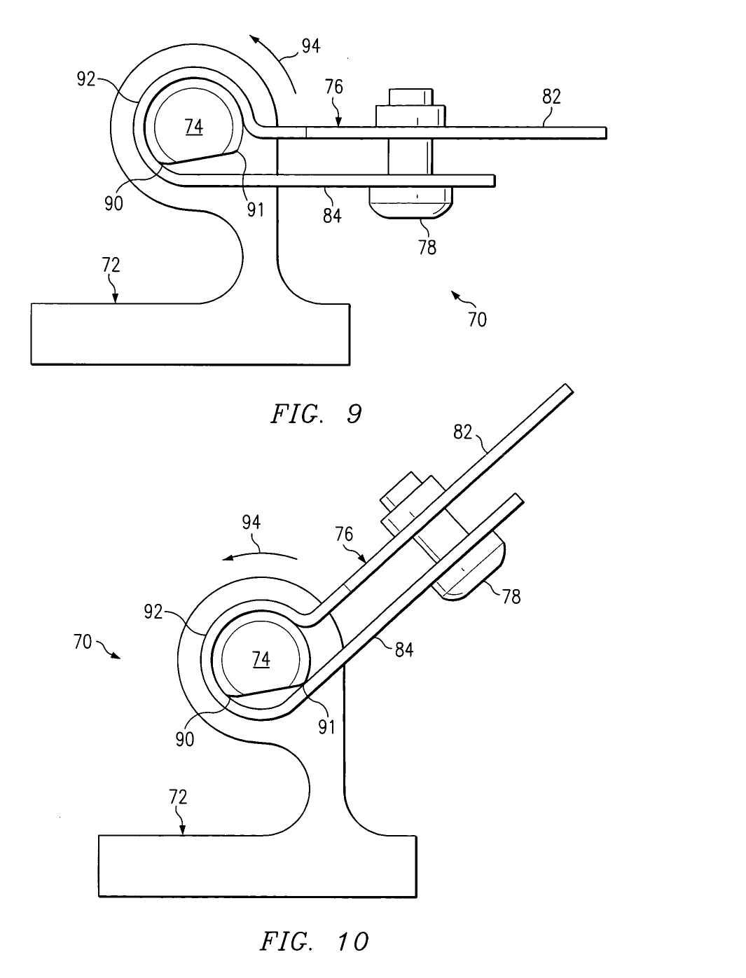

FIG. 9 is a diagrammatic side view of the friction hinge assembly 70 as positioned when the imaging mirror 49 to which the hinge member 76 couples is in a recessed position (such position as illustrated in FIG. 4). In operation, when the imaging mirror 49 of the display unit 40 is released from a recessed, latched position, the lift mechanism of FIG. 8 rotates the hinge member 76 of the friction hinge assembly 70 in the general direction represented by arrow 94 about pin portion 74 of mounting base 72. Since the hinge member 76 is coupled to the imaging mirror 49, the imaging mirror rotationally deploys from its recessed position. Mounting base 72 remains in a fixed position coupled to the housing 52. Such rotation of the hinge member 76 (and the imaging mirror 49 coupled to the hinge member 76) occurs without substantial friction until support portion 84 of the hinge member 76 contacts corner 91 of the pin portion 74.

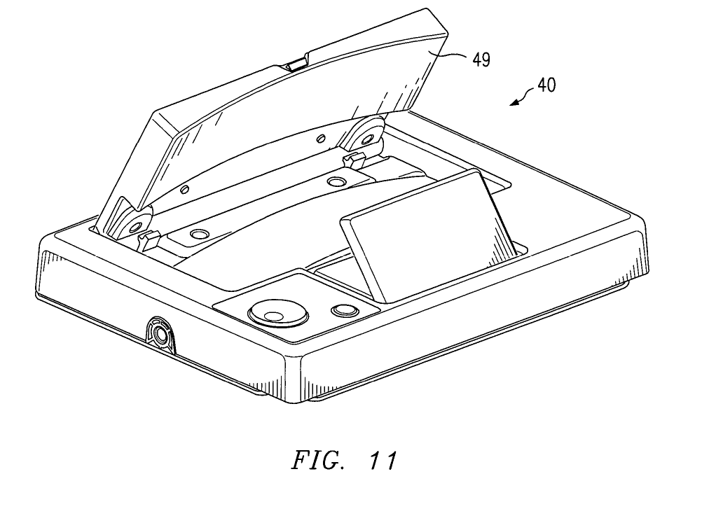

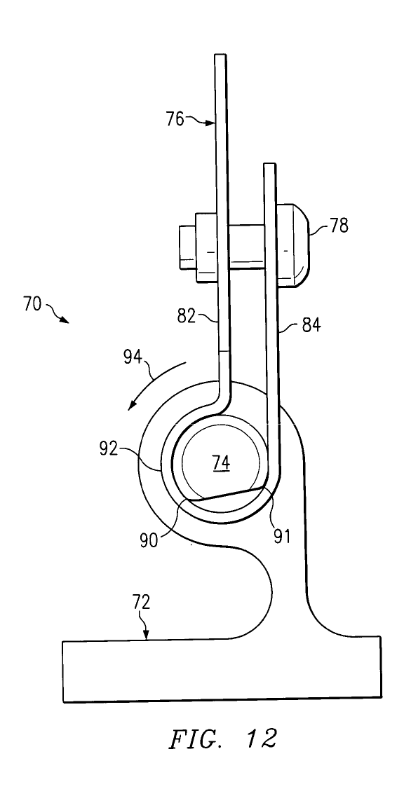

FIG. 10 is a diagrammatic side view of the friction hinge assembly 70 as positioned when the imaging mirror to which the hinge member 76 couples is in a partially deployed position (as illustrated in FIG. 11 described below). At such position, support portion 84 of hinge member 76 has come into contact with corner 91 of pin portion 74 during the rotational movement of the hinge member 76 about pin portion 74. Further rotation of the hinge member 76 about the pin portion 74 in the general direction represented by arrow 94 (and resulting further rotational deployment of the imaging mirror 49 coupled to the hinge member 76) will occur with friction resulting from the contact of support portion 84 of the hinge member 76 with corner 91 of pin portion 74. The use of adjustment screw 78 to affect the amount of such friction and the position at which such friction begins during deployment is further discussed below.

FIG. 11 is a diagrammatic isometric view of a display unit 40 with imaging mirror 49 in the approximate partially deployed position when the friction hinge assemblies 70 (covered from view) coupled to the imaging mirror 49 are in the position as illustrated in FIG. 10. The imaging mirror 49 may be further rotated with friction to a fully deployed position, such as the position of the imaging mirror 49 in FIG. 5. The position of the friction hinge assemblies 70 after such rotation is described below with respect to FIG. 12.

FIG. 12 is a diagrammatic side view of the friction hinge assembly 70 as positioned when the imaging mirror to which the hinge member 76 is coupled is in a deployed position (as illustrated in FIG. 5). The hinge member 76 has been rotated about the pin portion 74 in the general direction represented by arrow 94. The rotation that has occurred between the position of the hinge member 76 in FIG. 10 and the position of the hinge member 76 in FIG. 12 relative to the pin portion 74 has occurred with friction caused by the contact of corner 91 with support portion 84 of the hinge member 76. The contact of corners 90 and 91 with curved intermediate side 92 may also provide some friction during the rotation.

The amount of friction during rotation and the point at which such friction begins during rotational deployment of the imaging mirror is controlled by increasing or decreasing the amount of space between mounting portion 82 and support portion 84. For example, the adjustment screw 78 may be tightened thereby decreasing the amount of space between mounting portion 82 and support portion 84 and thus increasing the amount of friction between corner 91 and support portion 84. The tightening of adjustment screw 78 also causes corner 91 to contact support portion 84 sooner during deployment thereby causing the friction to occur sooner. The adjustment screw 78 may also be loosened thereby increasing the amount of space between mounting portion 82 and support portion 84 and thus decreasing the amount of friction provided by the friction hinge assembly. The use of the screw to adjust the friction is useful to account for wear and tear of the friction hinge assembly over time and to account for manufacturing tolerances in the production of components of the friction hinge assembly.

The configuration of the pin portion 74 controls the friction and allowably free rotational travel of the hinge member 76 relative to the pin portion 74. By varying the configuration of the pin portion 74, more particularly in this embodiment the location of corners 90 and 91, the amount of free friction-less rotational travel (occurring in the rotation between the positions illustrated in FIGS. 9 and 10) may be changed.

The friction that occurs during the rotation allows a user to rotate the imaging mirror 49 coupled to the hinge member 76 to a suitable viewing position. After the user has rotated the imaging mirror 49 to such viewing position, the imaging mirror 49 will remain in that position as a result of such friction until the user desires to rotate the imaging mirror 49 to a new position or to return the imaging mirror 49 to its recessed position. The friction also keeps the imaging mirror 49 in place while being subject to vibrations and other movements occurring in a vehicle under typical driving conditions.

It should be understood that the fully deployed position of the imaging mirror 49 may vary according to the user of the display unit and the vehicle in which the display unit is being used. For example, because of varying physical attributes of different users and because of varying characteristics of different vehicles in which the display unit may be used, the deployed position of the imaging mirror may vary in order to provide the optimal viewing angle for a particular user in a particular vehicle. Thus, the deployed positions of the hinge member 76 relative to the mounting base 72 in FIG. 12 and the deployed position of the imaging mirror 49 of FIG. 5 may vary in other embodiments depending on a particular user, the particular vehicle in which the display unit 40 is being utilized, or other characteristics. The position of corner 91 of the friction hinge assembly 70 relative to support portion 84 when the imaging mirror is being used may also vary.

Although the present invention has been described in detail, various changes and modifications may be suggested to one skilled in the art. It is intended that the present invention encompass such changes and modifications as falling within the scope of the appended claims.

What is claimed is:

1. A friction hinge assembly for an imaging mirror of a display unit, comprising:
a mounting base coupled to a housing of the display unit, the mounting base comprising a longitudinal pin portion;
a hinge member coupled to the imaging mirror, the hinge member positioned substantially around the pin portion, the hinge member comprising a support portion;
wherein the pin portion is configured to apply a friction caused by contact of the pin portion with the support portion of the hinge member;
wherein the hinge member is configured to rotate about the pin portion from a first position to a second position without the friction; and
wherein the hinge member is configured to rotate about the pin portion from the second position to a third position with the friction.

2. The friction hinge assembly of claim 1, wherein the pin portion comprises at least one corner configured to contact the support portion of the hinge member to apply the friction.

3. The friction hinge assembly of claim 1, wherein the imaging mirror is in a recessed position within the housing when the hinge member is in the first position.

4. The friction hinge assembly of claim 1, wherein the imaging mirror is in a fully deployed position when the hinge member is in the third position.

5. The friction hinge assembly of claim 1, wherein the hinge member comprises a mounting portion spaced apart from the support portion, the mounting portion coupled to the imaging mirror.

6. The friction hinge assembly of claim 5, further comprising an adjustment screw inserted through the mounting portion and the support portion to control the friction.

7. The friction hinge assembly of claim 6, wherein the adjustment screw is configured to increase the friction by reducing the space between the support portion and the mounting portion when tightened.

8. The friction hinge assembly of claim 6, wherein the adjustment screw is configured to decrease the friction by increasing the space between the support portion and the mounting portion when loosened.

9. A system for displaying an image at a display unit, comprising:
a mounting base coupled to a housing of the display unit, the mounting base comprising a longitudinal pin portion;
a hinge member coupled to the imaging mirror, the hinge member positioned substantially around the pin portion, the hinge member comprising a support portion;
wherein the pin portion is configured to apply a friction caused by contact of the pin portion with the support portion of the hinge member;
wherein the hinge member is configured to rotate about the pin portion from a first position to a second position without the friction;
wherein the hinge member is configured to rotate about the pin portion from the second position to a third position with the friction; and
a video source coupled to the display unit to transmit the image to the display unit for reflection by a fold mirror coupled to the housing toward the imaging mirror.

10. The system of claim 9, wherein the pin portion comprises at least one corner configured to contact the support portion of the hinge member to apply the friction.

11. The system of claim 9:
wherein the hinge member comprises a mounting portion spaced apart from the support portion, the mounting portion coupled to the imaging mirror; and
further comprising an adjustment screw inserted through the mounting portion and the support portion to control the friction.

12. The system of claim 9, wherein the video source comprises a camera unit of an auxiliary vision system of a vehicle.

13. The system of claim 9, wherein the video source comprises a global positioning satellite system.

14. The system of claim 9, wherein the display unit comprises a liquid crystal display operable to project the image onto the fold mirror for reflection toward the imaging mirror.

15. A method for rotating an imaging mirror of a display unit with a friction hinge assembly, comprising:
rotating a hinge member about a longitudinal pin portion of a mounting base from a first position to a second position without friction caused by contact of the pin portion with a support portion of the hinge member, wherein the mounting base is coupled to a housing of the display unit, and wherein the hinge member is positioned substantially around the pin portion and is coupled to the imaging mirror; and
rotating the hinge member about the pin portion from the second position to a third position with the friction.

16. The method of claim 15, wherein the friction is caused by contact by at least one corner of the pin portion with the support portion of the hinge member.

17. The method of claim 15, wherein the imaging mirror is in a recessed position within the housing when the hinge member is in the first position.

18. The method of claim 15, wherein the imaging mirror is in a fully deployed position when the hinge member is in the third position.

19. The method of claim 15, wherein the hinge member comprises a mounting portion spaced apart from the support portion, the mounting portion coupled to the imaging mirror.

20. The method of claim 19, further comprising controlling the friction with an adjustment screw inserted through the mounting portion and the support portion.

21. The method of claim 20, further comprising tightening the adjustment screw to increase the friction by reducing the space between the support portion and the mounting portion.

22. The method of claim 20, further comprising loosening the adjustment screw to decrease the friction by increasing the space between the support portion and the mounting portion.

23. A method for displaying an image at a display unit, comprising:
receiving an image from a video source coupled to the display unit;
rotating a hinge member about a longitudinal pin portion of a mounting base from a first position to a second position without friction caused by contact of the pin portion with a support portion of the hinge member, wherein the mounting base is coupled to a housing of the display unit, and wherein the hinge member is positioned substantially around the pin portion and is coupled to the imaging mirror;
rotating the hinge member about the pin portion from the second position to a third position with the friction;
projecting the image onto a fold mirror coupled to the housing; and
reflecting the image onto the imaging mirror.

24. The method of claim 23, wherein receiving an image from a video source comprises receiving an image from a camera unit of an auxiliary vision system of a vehicle.

25. The method of claim 23, wherein receiving an image from a video source comprises receiving an image from a global positioning satellite system.
